(19) United States
(12) Patent Application Publication
(10) Pub. No.: US 2013/0244488 A1
(43) Pub. Date: Sep. 19, 2013

(54) CONNECTOR STRUCTURE

(71) Applicant: Janesko Oy, (US)

(72) Inventor: Saku Lähteenmäki, Hyvinkaa (FI)

(73) Assignee: JANESKO OY, Vantaa (FI)

(21) Appl. No.: 13/829,376

(22) Filed: Mar. 14, 2013

(30) Foreign Application Priority Data
Mar. 16, 2012 (FI) 20125291

(51) Int. Cl. H01R 13/52

(52) U.S. Cl. CPC H01R 13/5213
USPC 439/587

(57) ABSTRACT

A connector structure includes a connector element arranged to form a disengageable conductor connection between a first conductor part in a space surrounded by a body of a device and a second conductor part in surroundings of the device. The connector element includes first and second connector parts to be arranged at corresponding ends of the first and second conductor parts, respectively. The connector parts have compatible coupling parts to be engaged/disengaged to/from each other and to provide a disengageable conductor connection between the conductor parts. The connector part includes a cover part arranged in the second conductor part so that the second conductor part is arranged to pass sealingly through a wall of the cover part. The cover part is arranged, in a coupling situation, to press tightly against the body of the device and to form around the connector element a tight space closed from the surroundings.

### RELATED APPLICATIONS

This application claims priority under 35 U.S.C. §119 to Finnish Patent Application No. 20125291 filed in Finland on Mar. 16, 2012, the entire content of which is hereby incorporated by reference in its entirety.

### FIELD

The present disclosure relates to a connector structure which includes a connector element having first and second connector parts which may be engaged to each other and, correspondingly, disengaged from each other to provide a disengageable conductor connection between the connector parts, and a cover part providing a sealing connection.

The present disclosure also relates to connector structures, such as connector structures which provide, for example, an electric or pneumatic connection between a device and, for example, a driving power source.

### BACKGROUND INFORMATION

Various industrial environments create high requirements for connector structures to be used. For example, the hard environmental conditions of the semiconductor industry and the prohibition of use of metallic material cause a problem to the use of different connectors. Among known solutions, there is no connector structure that would be well suited to such hard environmental conditions. Known connector structures include metallic material, such as nickel-plated brass or stainless steel. Such solutions are not sufficient for providing a long-term reliable connector in aggressive conditions. On the other hand, the device users need a connector structure for increased practicality, for instance in maintenance and mounting operations, and therefore structures cannot, in practice, be implemented without any connector structures.

### SUMMARY

An exemplary embodiment of the present disclosure provides a connector structure which includes a connector element arranged to form a disengageable conductor connection between a first conductor part in a space surrounded by a body of a device, and a second conductor part in surroundings of the device. The connector element includes a first connector part configured to be arranged at an end of the first conductor part, and a second connector part to be arranged at an end of the second conductor part. The first and second connector parts have compatible coupling parts such that the first and second connector parts are configured to be engaged to each other and disengaged from each other to provide a disengageable conductor connection between the first and second connector parts. The connector structure includes a cover part arranged in the second conductor part so that the second conductor part is arranged to pass sealingly through a wall of the cover part. The cover part is configured to be arranged, in a coupling situation, to press tightly against the body of the device and to form around the connector element a gas-tight space closed from the surroundings of the device. The body and the cover part respectively include compatible fastening parts by which the cover part is configured to press against the body.

### BRIEF DESCRIPTION OF THE DRAWINGS

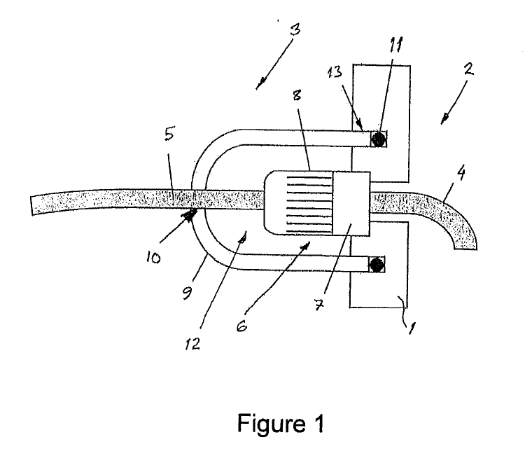

Additional refinements, advantages and features of the present disclosure are described in more detail below with reference to FIG. 1, which schematically shows an exemplary embodiment of a connector structure according to the present disclosure.

### DETAILED DESCRIPTION

Exemplary embodiments of the present disclosure provide a connector structure which eliminates the disadvantages of known techniques. According to an exemplary embodiment of the present disclosure, a connector structure includes a cover part arranged in a second conductor part in such a way that the second conductor part is arranged to pass sealingly through a wall of the cover part. The cover part is arranged, in a coupling situation, to press tightly against the body of the device and to form around the connector element a gas-tight space closed from the surroundings. The body and the cover part are provided with compatible fastening parts by which the cover part is arranged to press against the body.

The connector structure of the present disclosure advantageously provides simplicity and versatility. Owing to the simple structure, it is advantageous to introduce and use the disclosure. Owing to its versatility, the present disclosure is advantageously applicable anywhere where connections are needed against the aggressiveness of the environment. Another advantage of the present disclosure is that the cover part also gives the connections mechanical protection against impacts and dents, for example.

Exemplary embodiments of the present disclosure will be explained in more detail in the following by means of a working example shown in the FIG. 1, which illustrates a schematic side view of an exemplary embodiment of a connector structure according to the present disclosure.

FIG. 1 shows schematically an exemplary embodiment of the connector structure according to the present disclosure. Reference numeral 1 denotes a device body, while reference numeral 2 shows a space inside the device body, separated from the surroundings of the device by the device body 1. Surroundings of the device are denoted with reference numeral 3.

A first conductor part is denoted with reference numeral 4. The first conductor part 4 is in the space 2 inside the body 1 of the device. A second conductor part is denoted with reference numeral 5. The second conductor part 5 is positioned in the surroundings 3 of the device. In this context, the term ‘conductor part’ is to be understood in a wide sense, for example, the conductor part may be an electric conductor, pneumatic conductor, hydraulic conductor, etc.

The connector element is shown in FIG. 1 generally by reference numeral 6. The connector element 6 includes a first connector part 7 to be arranged at an end of the first conductor part 4, and correspondingly, a second connector part 8 to be arranged at an end of the second conductor part 5. The connector parts 7 and 8 have compatible coupling parts arranged to engage each other to provide coupling. The coupling parts may be, for example, electric connector parts, connector parts providing pneumatic or hydraulic coupling, etc., depending on which conductor parts are involved.

The connector parts 7, 8 of the connector element 6 may be engaged to each other and, correspondingly, disengaged from each other to provide a disengageable conductor connection from the surroundings 3 of the body 1 to the space 2 inside the body 1.

In accordance with the illustrated exemplary embodiment, the connector structure includes a cover part 9. The cover part 9 allows the connector element 6, for example, the connector parts 7, 8, to be protected against the aggressive surroundings 3 without risking the tightness of the body 1 of the device. The cover part 9 tightens at its one end against the body 1, as shown in FIG. 1. The cover part 9 is arranged in the second conductor part 5 in such a way that the second conductor part 5 passes sealingly through a wall of the cover part 9. Sealing between the second conductor part 5 and the cover part 9 is provided by means of an appropriate lead-through 10, such as a seal or a tight fit, for example. In accordance with an exemplary embodiment, the lead-through 10 is formed in such a way that the cover part 9 can slide in the longitudinal direction of the second conductor part 5.

The cover part 9 tightens against the body 1 at its one end, as noted above. In connection with the tightening of the cover part 9, a suitable seal, such as an O ring 11, for example, could naturally also be used. Pressing of the cover part 9 tightly against the body 1 and attachment of the cover part 9 to the body 1 can be implemented in any suitable manner. Examples of suitable implementations include an application by a pair of female and male threads, bayonet type fastening, fastening by means of screws, etc. In accordance with an exemplary embodiment, the fastening allows the cover part 9 to press sufficiently intensely against the body 1, which results in a tight connection. Thus, around the connector element 6, a protected and closed space 12 is provided to which no harmful gases or substances, for example, can arrive from the surroundings 3. The space 2 formed by the body 1 of the device is a protected environment without any harmful gases and/or substances. That is, the term ‘sealingly’ above refers to gas-tight sealing.

In this context, a simpler example of the connector structure of the present disclosure may be represented by a structure in which the side of the device has a first connector part 7 of an electric M12 connector element 6 mounted on the body 1. A conductor part 5 is connected to the connector part 7 by means of a second connector part 8 of the M12 connector element 6. The M12 connector element 6 provides reliable electric contact but a connector made of metallic material is not protected against external, often corrosive conditions prevailing in the surroundings 3 of the device.

In accordance with an exemplary embodiment of the present disclosure, the conductor part 5 is, at the assembly stage, provided with a cover part 9 in such a way that the conductor part 5 passes sealingly through one end of the cover part 9, as described above. After an electric connection has been provided and the connector parts 7 and 8 are engaged to each other, the cover part 9 is moved upon the connector element 6 in the direction of the conductor part 4 in such a way that one end of the cover part 9 is sealingly pressed against the body 1. This situation is shown in FIG. 1.

In the example of FIG. 1, one end of the cover part 9 is pushed into an annular groove arranged in the body. An O ring 11 is arranged in the annular groove. It is naturally feasible to use other types of seal means as well. Further, it is feasible to provide a tight connection without any seal means. For example, in connection with the annular groove, suitable fastening parts, such as threads, may be provided which are arranged to act together with the thread at the end of the cover part 9. Thus, the cover part 9 can be screwed, by means of the joint action of the threads, to engage the body 1. The above-described fastening parts, such as threads, are shown in the FIGURE by reference numeral 13. It is to be understood, however, that the cover part 9 may also be fastened to the body 1 with members of other types within the basic idea of the present disclosure, as noted above.

The above seal structure allows the M12 connector element 6 to be protected against gases and splashes from the surroundings. In this context, it is also to be noted that the cover part 9 also protects the connector element 6 mechanically. In other words, the cover element 9 also serves as a protector against impacts and other dents.

The present disclosure is described above with reference to a working example of a specific type. However, the present disclosure is not, by any means, restricted to the examples described herein, but it may also be implemented in another way. The present disclosure may be freely modified within the scope of the attached claims. For instance, conductor connections are not confined to electric conductors but the conductor element may also be a pneumatic conductor, hydraulic conductor, etc. The cover part may also be arranged to surround more than one connector element, or alternatively several connector structures according to the present disclosure may be arranged in the same structure, which may be, for example, a temperature sensor used in the semiconductor industry.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A connector structure, comprising:
a connector element arranged to form a disengageable conductor connection between a first conductor part in a space surrounded by a body of a device, and a second conductor part in surroundings of the device,
wherein the connector element includes a first connector part configured to be arranged at an end of the first conductor part, and a second connector part to be arranged at an end of the second conductor part,
wherein the first and second connector parts have compatible coupling parts such that the first and second connector parts are configured to be engaged to each other and disengaged from each other to provide a disengageable conductor connection between the first and second connector parts,
wherein the connector structure comprises a cover part arranged in the second conductor part so that the second conductor part is arranged to pass sealingly through a wall of the cover part,
wherein the cover part is configured to be arranged, in a coupling situation, to press tightly against the body of the device and to form around the connector element a gas-tight space closed from the surroundings of the device, and
wherein the body and the cover part respectively include compatible fastening parts by which the cover part is configured to press against the body.

2. A connector structure according to claim 1, wherein the cover part is arranged slidingly in the second conductor part.

3. A connector structure according to claim 2, wherein the cover part is arranged to press against the body by seal means.

4. A connector structure according to claim 1, wherein the compatible fastening parts are formed as integral parts of the body and the cover part.

5. A connector structure according to claim 1, wherein the compatible fastening parts are thread parts.

6. A connector structure according to claim 1, wherein the cover part is arranged to press against the body by seal means.
